(19) United States
(12) Patent Application Publication
(10) Pub. No.: US 2005/0154935 A1
(43) Pub. Date: Jul. 14, 2005

(54) Mobile terminal and method for auto-locking thereof

(75) Inventor: Jeong-Gyu Jin, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/939,695

(22) Filed: Sep. 13, 2004

(30) Foreign Application Priority Data
Jan. 12, 2004 (KR) 2021-2004

(51) Int. Cl. H04K 1/00

(52) U.S. Cl. 713/324

(57) ABSTRACT

Disclosed is a method for automatically locking a mobile terminal having functions, such as incoming and outgoing calls. The method includes the steps of setting an auto-lock time period to restrict the use of one or more predetermined functions; activating an auto-lock mode to restrict the use of the predetermined functions during the auto-lock time period; and inactivating the auto-lock mode after the auto-lock time period. The auto-lock mode for automatically locking functions of the mobile terminal can be set to be activated only during specified time or during all other times of the day according to the spatial and temporal patterns of the user's daily routine.

### PRIORITY

This application claims priority to an application entitled “Mobile Terminal and Method for Auto-Locking Thereof” filed with the Korean Intellectual Property Office on Jan. 12, 2004 and assigned Serial No. 2004-2021, the contents of which are hereby incorporated by reference.

### BACKGROUND OF THE INVENTION

1. Field of the Invention

The present invention relates to a mobile terminal, and more particularly to a mobile terminal having an auto-locking feature and a method for automatically locking a mobile terminal to safeguard private information and prevent unauthorized use of the mobile terminal even when lost without being manually locked.

2. Description of the Related Art

Recently, mobile terminals have been widely supplied due to their improved portability and convenience. It is a current trend that mobile terminals are becoming increasingly more integrated to provide for telephone services that can perform additional functions, such as phone book, scheduler, memo and messaging functions. Such mobile terminals are used to manage personal information.

Among control functions available in a mobile terminal are a variety of locking functions for restricting the use of the mobile terminal, making it possible to prevent others from using the mobile terminal by activating a locking function.

In order to activate a locking function selected from menus on the mobile terminal, it is generally required to enter a password that has been previously inputted and stored in the mobile terminal.

When the mobile terminal is locked, the user can only receive incoming calls. The locking function enables protection of the private information stored in the mobile terminal, such as telephone numbers, schedules, memos and messages, and prevents unauthorized use of the mobile terminal including making outgoing calls.

Accordingly, once a conventional mobile terminal is set to be locked, it cannot be used until or unless it is unlocked by the user inputting a password. The user has to enter a designated password to unlock the mobile terminal whenever making a call or searching for any private information stored in the mobile terminal, such as a telephone number, a schedule, a memo or a message. However, due to such inconvenience of having to enter the designated password, the user may release or may never use the locking function.

If the user stays in one place (such as an office) during specific hours each day (for example, during working hours), it is unlikely that the user will lose his or her mobile terminal during that time. Even if the mobile terminal is lost, the user can easily find the missing terminal by enlisting the help of colleagues working in the same office. However, if the user loses the mobile terminal in a crowded public place after work, the user will have difficulty finding the missing terminal. Accordingly, it has been recommended that the mobile terminal be locked after work.

Users such as housewives may not need to lock their mobile terminals at home. In order to prepare for an accidental loss of mobile terminals, they may activate a locking function only when going out. However, it is troublesome and inconvenient for such users to have to remember to lock the terminal when going out and to unlock the terminal when returning home.

Conventional mobile terminals can be manually locked or unlocked, regardless of the specific time of day. In order to solve any inconvenience caused by such a simple locking function, it is necessary to enable a mobile terminal to be automatically locked during specified hours each day. When conventional mobile terminals are locked, all functions other than incoming calls are restricted. In such mobile terminals, it is not possible to selectively lock various functions according to the security level of each function.

### SUMMARY OF THE INVENTION

Accordingly, the present invention has been made to solve the above-mentioned problems occurring in the prior art, and an object of the present invention is to provide a mobile terminal and a method for restricting the use of various functions, such as incoming and outgoing calls, during specified hours each day according to the spatial and temporal patterns of a user's daily routine.

Another object of the present invention is to provide a mobile terminal capable of restricting various functions, thereby preventing others from using such functions, protecting private information and preventing unauthorized use, as well as providing a method for automatically locking a mobile terminal.

In order to accomplish the above objects of the present invention, there is provided a method for automatically locking a mobile terminal having functions, such as incoming and outgoing calls, said method comprising the steps of setting an auto-lock time period to restrict the use of one or more predetermined functions; activating an auto-lock mode to restrict the use of the predetermined functions during the auto-lock time period; and inactivating the auto-lock mode after the auto-lock time period.

In order to accomplish the above objects of the present invention, there is also provided a mobile terminal having functions, such as incoming and outgoing calls and short messages, which comprises a memory for storing an auto-lock time period to restrict the use of one or more predetermined functions; and a control section for activating an auto-lock mode to restrict the use of the predetermined functions during the auto-lock time period and inactivating the auto-lock mode after the auto-lock time period.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing the structure of a mobile terminal according to the present invention;

FIG. 2 is a view showing a menu for selecting functions to be locked in a mobile terminal according to the present invention;

FIG. 3 is a view showing a menu for setting an auto-lock time period according to one embodiment of the present invention;

FIG. 4 is a view showing a menu for setting auto-locking times according to another embodiment of the present invention;

FIG. 5 is a flow chart showing a process for setting an auto-lock mode in a mobile terminal according to the present invention;

FIG. 6 is a flow chart showing a process for activating an auto-lock feature in a mobile terminal according to a first embodiment of the present invention;

FIG. 7 is a flow chart showing a process for activating an auto-lock feature in a mobile terminal according to a second embodiment of the present invention; and

FIG. 8 is a flow chart showing a process for activating an auto-lock feature in a mobile terminal according to a third embodiment of the present invention.

### DETAILED DESCRIPTION OF THE PREFERRED EMBODIMENTS

Hereinafter, preferred embodiments of the present invention will be described with reference to the accompanying drawings. In the drawings, the same element, although depicted in different drawings, will be designated by the same reference numeral or character. Although certain elements, such as a circuit device, are specifically defined in the following description of the present invention, it will be obvious to those skilled in the art that such definitions of elements are provided merely to improve the understanding of the present invention and that the present invention can be carried out without such specific elements. Also, in the following description of the present invention, a detailed description of known functions and configurations incorporated herein is omitted to avoid making the subject matter of the present invention unclear.

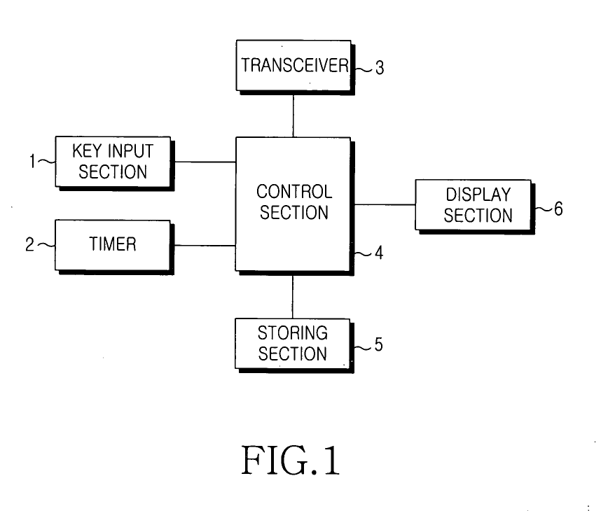

As shown in FIG. 1, a mobile terminal according to the present invention comprises a key input section 1, a timer 2, a transceiver 3 for wireless data receiving and transmission, a speaker (not shown) for outputting speech signals, a microphone (not shown) for inputting speech signals, a display section 6 typically comprising an LCD (liquid crystal display) to display images, a storing section 5 for storing various data required to operate the mobile terminal and a control section 4 for controlling overall operations of the mobile terminal.

According to the present invention, it is possible to restrict the use of certain functions, such as incoming and outgoing calls, short messages and phone book, for the management and protection of the user's personal data. Also, such functions can be locked automatically during specified hours each day.

The storing section 5 stores information about auto-lock settings and software for displaying a menu for setting an auto-lock time period and stores auto-lock data inputted through the key input section 1. The storing section 5 also stores a time to unlock. The time to unlock is a preset period of time during which the auto-lock mode of the mobile terminal can be released according to the user's demand to unlock. The storing section 5 may be provided in a memory of the mobile terminal.

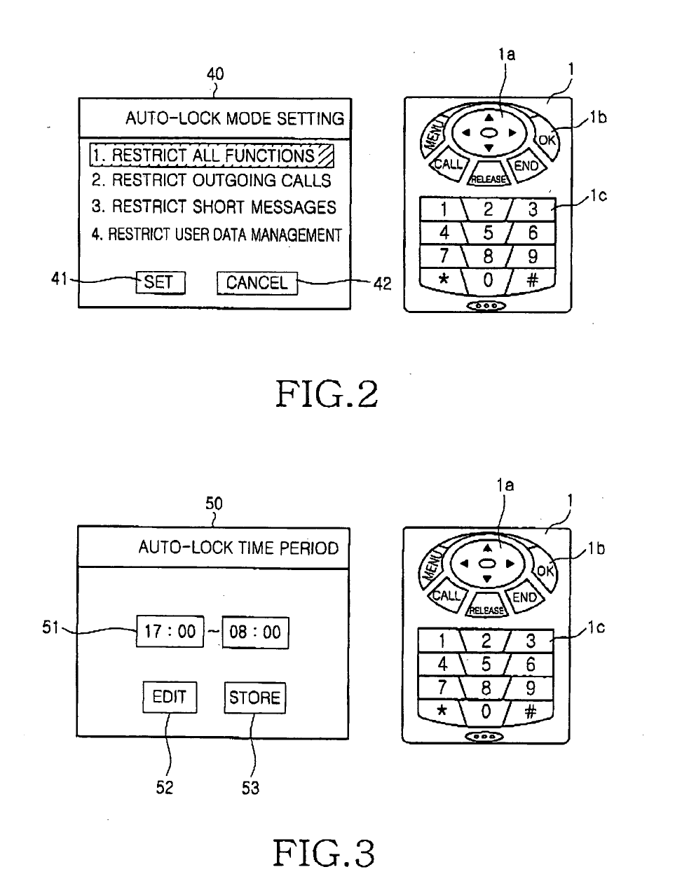

The control section 4 controls the function of the mobile terminal, including performing mobile communications. According to the present invention, the control section 4 implements the software stored in the storing section 5 to display a menu 40 for selecting functions to be locked as shown in FIG. 2 and a menu 50 for setting a time for an auto lock schedule as shown in FIG. 3 on the display section 6. The user can select a function or functions desired to be locked and input a desired auto-lock time period while the menus 40 and 50 are displayed. The selected function(s) and the inputted time are stored in the storing section 5.

FIG. 2 shows the menu 40 for selecting functions to be locked. FIG. 3 shows the menu 50 for setting a time for an auto lock schedule. As shown in FIG. 2, functions that can be set to be locked or unlocked are displayed as items of the menu 50. The first item “restrict all functions” can be selected to restrict the use of, or lock, all functions available in the mobile terminal. The second item “restrict outgoing calls” can be selected to restrict making outgoing calls. The third item “restrict short messages” can be selected to restrict sending short messages. The fourth item “restrict user data management” can be selected to restrict access to or management of stored short messages, telephone numbers and other personal data. Although not shown in FIG. 2, additional items for restricting international calls, display of a caller's telephone number, etc. can be provided in menu 40. It is also possible to classify functions into several groups according to security levels and to simultaneously restrict a plurality of functions by selecting one group to be locked.

When the menu 40 is displayed, a “set” icon 41 for setting any selected functions to be locked and a “release” icon 42 for releasing the lock mode are also displayed. The user can select the “set” icon 41 or the “release” icon 42 using the key input section 1. Upon setting of certain functions to be locked in the menu 40, the menu 50 as shown in FIG. 3 is displayed so that the user can input a time period 51 (i.e. from/to or start/stop times) for locking the functions, and then edit or store the inputted time by selecting an “edit” icon 52 or a “store” icon 53. The user can input a desired time using direction keys 1a and/or number keys 1c provided on the key input section 1.

If the user presses an “OK” key 1b and thereby selects the “store” icon 53, the inputted auto-lock data will be stored. As shown in FIG. 3, an auto-lock time period from 17:00 to 08:00 can be set, and the selected functions will be automatically locked from 17:00 to 08:00. Although not illustrated in FIG. 2 or 3, it will be recognized that it is also possible to set different locking times for different functions.

As explained above, if the user selects the auto-lock mode and sets a time period for certain functions in the menus 40 and 50, the functions will be automatically locked during the specified time period and unlocked during all other times of the day. Also, the user can set all functions, other than incoming calls, to be locked during certain hours each day. If the user selects functions to be locked and inputs a time for activating the auto-lock mode in the menus 40 and 50, the control section 4 in FIG. 1 will store the selected functions and the inputted time in the storing section 5.

Also, if the user inputs a demand to release the auto-lock mode with a password through the key input section 1, the control section 4 will release the auto-lock mode for a preset period of time. However, the control section 4 will reactivate the auto-lock mode after the preset period of time has lapsed. It is preferable that such a time period should be stored as an initial value of the mobile terminal in the storing section 5.

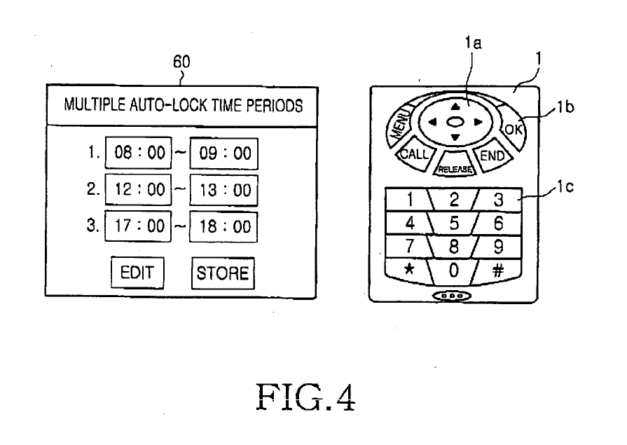

FIG. 4 is a view showing a menu 60 for setting multiple auto-lock time periods according to another embodiment of the present invention. As shown in FIG. 4, it is possible to set multiple auto-lock time periods for the selected functions. FIG. 4 shows multiple auto-lock time periods (i.e. from/to or start/stop times) inputted through the key input section 1. When the menu 60 is displayed, the user can input multiple auto-lock time periods between 00:00 and 24:00, as shown in FIG. 4.

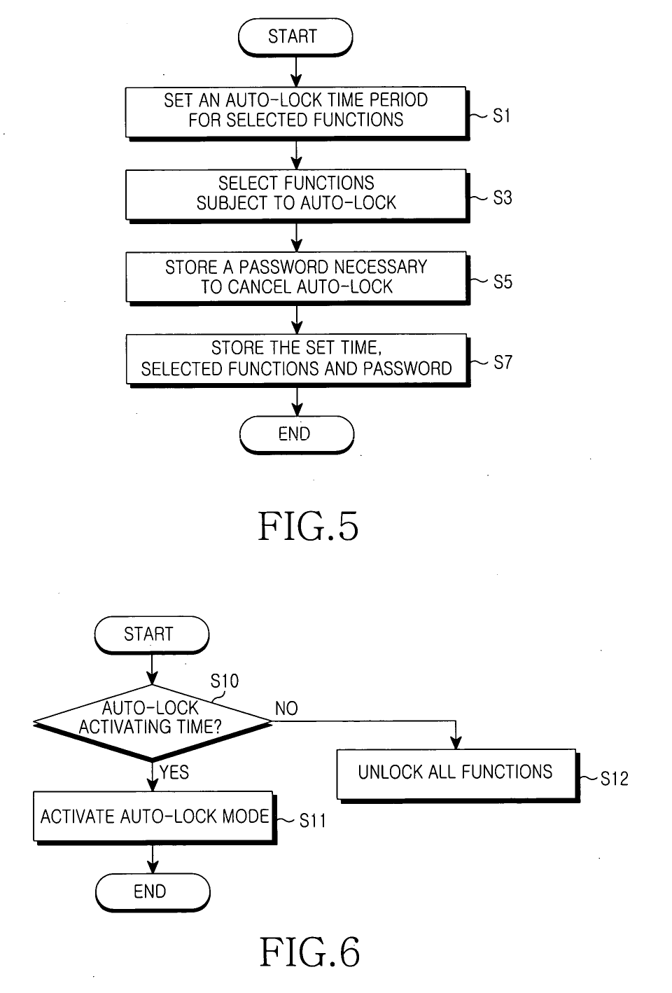

FIG. 5 is a flow chart showing a process for setting an auto-lock mode in a mobile terminal according to the present invention. Referring to FIG. 5, when the menu 50 as shown in FIG. 3 is displayed, the user can input a desired time for activating the auto-lock mode at step S1 Upon input of an auto-lock time period through the key input section 1, the menu 40 as shown in FIG. 2 is displayed on the display section 6 so that the user can select one or more functions to be locked from the items “restrict all functions,” “restrict outgoing calls,” “restrict short messages” and “restrict user data management.” At step S3, the user can change the functions subject to be locked in the menu 40 of FIG. 2.

When the user does not wish to change the functions (in other words, when the user wishes to set an auto-lock mode for the initially selected functions), the user can designate a password at step S5. The initial auto-lock setting data is stored in the storing section. It is preferable that the initial auto-lock setting should be a mode for locking all the functions excluding incoming calls. The control section 4 in FIG. 1 stores the functions selected to be locked and the auto-lock time period inputted by the user in the storing section 5. If the user inputs a demand to release the auto-lock mode with the designated password through the key input section 1 during the above auto-lock time period, i.e. during the auto-lock activation, the control section 4 will release the auto-lock mode. In other words, the control section 4 will temporarily inactivate the auto-lock mode for a preset period of time which is stored as an initial value of the mobile terminal in the storing section 5. The control section 4 will reactivate the auto-lock mode after the preset period of time has lapsed.

Hereinafter, a process of activating an auto-lock mode in a mobile terminal during a specified time period will be explained in detail.

FIG. 6 is a flow chart showing a process for activating an auto-lock mode according to the first embodiment of the present invention. At step S10, the control section 4 determines whether it is the time to activate the auto-lock mode. If it is, the control section 4 will activate the auto-lock mode to lock the selected functions at step S11. Otherwise, the control section 4 will inactivate the auto-lock mode to enable the user to implement any functions at step S12.

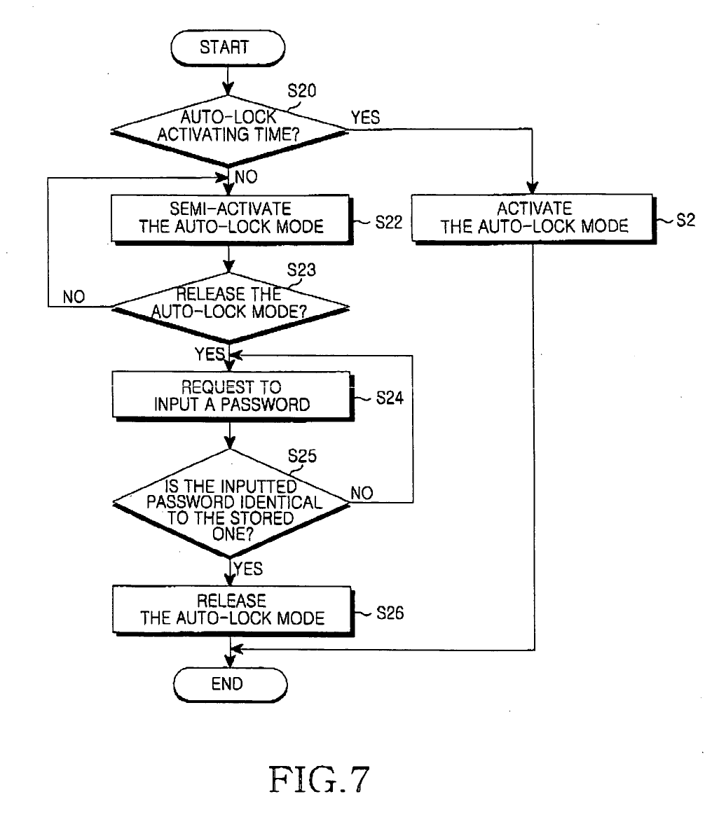

FIG. 7 is a flow chart showing a process for activating an auto-lock mode according to the second embodiment of the present invention. In this embodiment, the auto-lock mode is activated during a set auto-lock time period to restrict all functions of the mobile terminal and semi-activated during other times to enable the user only to receive incoming calls.

At step S20, the control section 4 determines whether it is time to activate the auto-lock mode. If it is not the auto-lock activating time, the control section 4 will semi-activate the auto-lock mode at step S22. In the semi-activated auto-lock mode, the control section 4 detects whether the user inputs a demand to release the auto-lock mode at step S23. The user can input the demand to release the auto-lock mode through the key input section 1 in order to use various functions, such as a menu selection. When the demand is inputted, the control section may require the user to directly input a password or press a function key.

Upon detecting the demand to release the auto-lock mode at step S23, the control section 4 proceeds with step S24 to display a picture or icon (not shown) requesting the user to input a password on the display section 6. At step S25, the control section 4 determines whether a password inputted by the user through the key input section 1 is identical to that stored in the storing section 5. If the inputted password is determined to be identical to the stored one at step S25, the control section 4 will proceed at step S26 to release the auto-lock mode, thereby unlocking and making accessible all functions of the mobile terminal.

If the control section 4 determines that it is the auto-lock activating time at step S20, it will proceed with step S21 to activate the auto-lock mode for restricting the use of all functions of the mobile terminal.

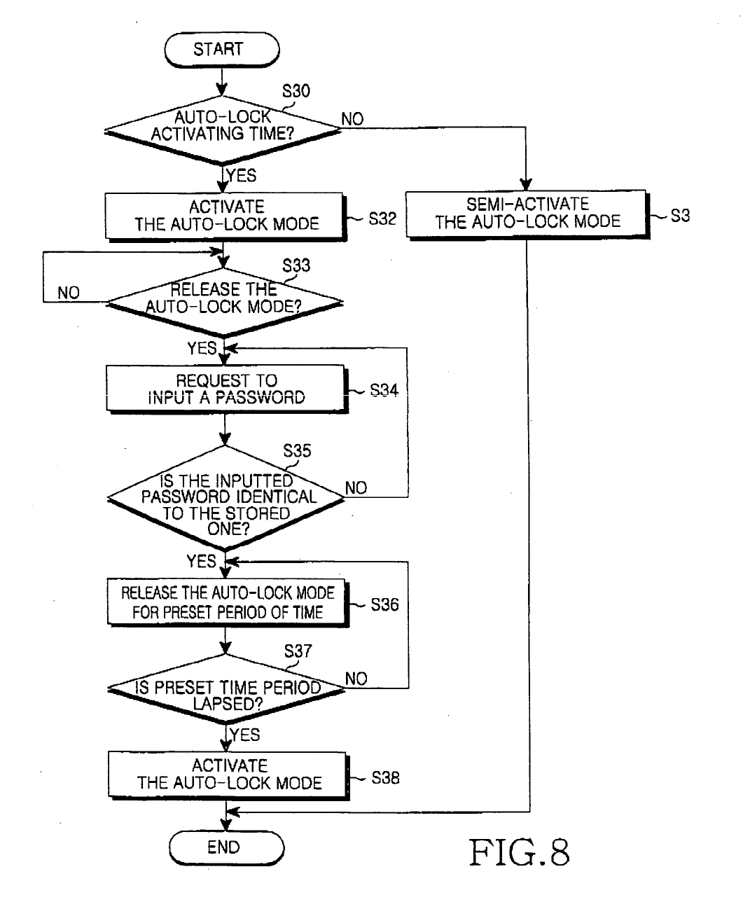

FIG. 8 is a flow chart showing a process for activating an auto-lock mode according to the third embodiment of the present invention. Referring to FIG. 8, the control section 4 determines whether it is time to activate the auto-lock mode at step S30. If it is the auto-lock activating time, the control section 4 will proceed with step S32 to activate the auto-lock mode. If the control section 4 detects that the user has inputted a demand to release the auto-lock mode at step S33, it proceeds with step S34 to display a picture or icon (not shown) requesting the user to input a password on the display section 6. At step S35, the control section 4 determines whether a password inputted by the user through the key input section 1 is identical to that stored in the storing section 5. If the inputted password is determined to be identical to the stored password at step S35, the control section 4 will proceed with step S36 to release the auto-lock mode for a preset period of time. Upon lapse of the preset time period at step S37, the control section 4 will reactivate the auto-lock mode at step S38. On the other hand, if it is not determined to be the auto-lock activating time at step S30, the control section 4 will semi-activate the auto-lock mode at step S31.

Although not explained in detail above, it will be recognized that it is possible to set different functions to be locked during different times that have been set as shown in FIG. 4. In such a case, certain functions, such as incoming and outgoing calls, can be used or restricted only during such specified times. For example, an auto-lock mode can be set to enable the user to use functions, such as incoming and outgoing calls, only during lunch or dinner time and to restrict the use of the functions during regular meeting times. Also, it is possible to lock any incoming calls during night time thereby providing for an uninterrupted, sound sleep.

According to the present invention, an auto-lock mode can be activated only during specified times or during all other times of the day according to the spatial and temporal patterns of the user's daily routine and occupation.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

1. A method for automatically locking a mobile terminal having functions, such as incoming and outgoing calls, said method comprising:
setting an auto-lock time period to restrict the use of one or more predetermined functions;
activating an auto-lock mode to restrict the use of the predetermined functions during the auto-lock time period; and
inactivating the auto-lock mode after the auto-lock time period.

2. The method according to claim 1, further comprising:
receiving a password inputted to release the auto-lock mode;
determining whether the inputted password is identical to a previously designated password;
when the inputted password is identical to the previously designated password, releasing the auto-lock mode for a preset period of time; and
activating the auto-lock mode again after lapse of the preset period of time.

3. The method according to claim 1, further comprising:
receiving a password inputted to release the auto-lock mode;
determining whether the inputted password is identical to a previously designated password; and
when the inputted password is identical to the previously designated password, releasing the auto-lock mode to unlock all functions available in the mobile terminal.

4. The method according to claim 1, further comprising:
determining current time using a timer; and
when the current time is a start time of the set auto-lock time period, activating the auto-lock mode.

5. The method according to claim 1, wherein said auto-lock time period includes a plurality of auto-lock time periods each corresponding to a function of the mobile terminal.

6. The method according to claim 1, further comprising changing said predetermined functions subject to be locked.

7. A method for automatically locking a mobile terminal having functions, such as incoming and outgoing calls, said method comprising:
setting a time period for normal use of the functions, such as incoming and outgoing calls; and
activating an auto-lock mode for restricting the use of all the functions, excluding incoming calls, outside of the normal use time period.

8. The method according to claim 7, further comprising:
setting a partial lock mode for restricting one or more predetermined functions during said normal use time period; and
activating the partial lock mode during said normal use time period.

9. The method according to claim 7, further comprising:
receiving a password inputted to release the auto-lock mode;
determining whether the inputted password is identical to a previously designated password;
when the inputted password is determined to be identical to the previously designated password, releasing the auto-lock mode for a preset period of time; and
reactivating the auto-lock mode after lapse of the preset period of time.

10. The method according to claim 7, further comprising:
determining the current time; and
when the current time is not within the normal use time period, activating the auto-lock mode.

11. The method according to claim 7, further comprising:
storing multiple normal use time periods inputted through a key input section; and
activating the auto-lock mode during all other times than the multiple normal use time periods.

12. A mobile terminal having functions, such as incoming and outgoing calls and short messages, which comprises:
a memory for storing an auto-lock time period to restrict the use of one or more predetermined functions; and
a control section for activating an auto-lock mode to restrict the use of the predetermined functions during the auto-lock time period and deactivating the auto-lock mode outside of the auto-lock time period.

13. The mobile terminal according to claim 12, wherein said control section receives a password inputted through a key input section to release the auto-lock mode, determines whether the inputted password is identical to a previously entered password stored in a memory, releases the auto-lock mode for a preset period of time if the inputted password is identical to the stored password, and reactivates the auto-lock mode after lapse of the preset period of time.

14. The mobile terminal according to claim 12, wherein said control section stores multiple auto-lock time periods inputted through a key input section in the memory and activates the auto-lock mode during the stored multiple auto-lock time periods.

15. A mobile terminal having functions, such as incoming and outgoing calls and short messages, which comprises:
a memory for storing a time period for normal use of the functions; and
a control section for activating an auto-lock mode to restrict the use of all the functions, excluding incoming calls, outside of the normal use time period.

16. The mobile terminal according to claim 15, wherein said control section stores data for setting a partial lock mode for restricting one or more predetermined functions during the normal use time period; and
activating the partial lock mode during said normal use time period.

17. The mobile terminal according to claim 15, wherein said control section stores a password to be used to release the auto-lock mode in the memory, determines whether a password inputted later through a key input section is identical to a password stored in the memory, releases the auto-lock mode for a preset period of time if the later inputted password is identical to the stored password, and reactivates the auto-lock mode again lapse of the preset period of time.

18. The mobile terminal according to claim 17, wherein said control section stores different auto-lock time periods inputted through the key input section to lock different functions in the memory, determines a current time using a timer, and activates the auto-lock mode when the current time is within an auto-lock time period.

19. The mobile terminal according to claim 16, wherein said control section stores multiple normal use time periods inputted through the key input section in the memory and normalizes all functions during the multiple normal use time periods.
